(19) United States
(12) Patent Application Publication
(10) Pub. No.: US 2004/0127179 A1
(43) Pub. Date: Jul. 1, 2004

(54) Dual polarization transmission receiving system and local oscillator phase noise reduction method

(75) Inventor: Eisaku Sasaki, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/715,564

(22) Filed: Nov. 19, 2003

(30) Foreign Application Priority Data
Nov. 20, 2002 (JP) 336762/2002

(51) Int. Cl. H04B 1/00; H04B 1/06; H04B 7/00

(52) U.S. Cl. 455/146; 455/130; 455/279.1

(57) ABSTRACT

A dual polarization transmission receiving system includes a reception unit including two RF local oscillators and a demodulation unit. The local oscillators receive signals transmitted by using two orthogonal polarized waves (V and H polarized waves) and convert the respective received signals into IF (Immediate Frequency) signals. The demodulation unit branches each IF signal into two paths, and then demodulates the respective IF signals for each polarized wave by a digital coherent detection scheme. The modulation unit for each polarized wave extracts a phase noise component from a demodulated output signal, divides the component into DC and AC components, and suppresses a phase noise amount received from an RF local oscillator for an orthogonally polarized (different polarized wave) relative to a polarized wave (self polarized wave) as a compensation target in the demodulation unit for each polarized wave by using a phase control signal obtained by interchanging the DC and AC components between the respective polarized waves.

### BACKGROUND OF THE INVENTION

The present invention relates to a dual polarization transmission receiving system using a reception local oscillator (LO) synchronization scheme and, more particularly, to a dual polarization transmission receiving system which prevents a deterioration in cross-polarization interference compensation characteristics due to phase noise originating from an independent reception local oscillator.

In order to improve the frequency utilization efficiency, a digital microwave communication apparatus uses a dual polarization transmission scheme of transmitting different signals by using two orthogonal polarization planes, i.e., a vertically (V) polarized wave and horizontally (H) polarized wave. When the same frequency is used for a V polarized wave and H polarized wave, an orthogonality error between polarization planes at an antenna or in a space causes leakage of signals from a V polarized wave into an H polarized wave or from an H polarized wave into a V polarized wave.

This leakage is called cross-polarization interference, which affects the transmission quality of a signal. The influence of this interference is especially noticeable when the dual polarization transmission scheme and a multilevel demodulation scheme such as QAM are used together. In general, therefore, interference components are removed by using an XPIC

(Cross-Polarization Interference Canceler).

If a polarized wave to be compensated for by using an XPIC is defined as a self polarized wave, and a polarized wave orthogonal thereto is defined as a different polarized wave, in order to compensate for interference from the different polarized wave on the receiving side, the phase relationship between a self polarized signal and an XPIC reference signal transferred from the different polarized wave must coincide with that at a stage in an RF (Radio Frequency) band subjected to different polarization side interference.

To satisfy this condition, the local oscillator (LO) frequencies for the self polarized wave and different polarized wave need to coincide with each other on at least one of the transmitting side and receiving side. As schemes of setting this local oscillator frequency, two schemes, i.e., a transmission local oscillator synchronization scheme and reception local oscillator synchronization scheme, are available.

In the transmission local oscillator synchronization scheme, since only a demodulator for signal demodulation is required, the arrangement on the receiving side can be simplified. However, a local oscillator synchronization circuit is required on the transmitting side to complicate a circuit arrangement. In addition, a complicated sequence is required to prevent influences on the different polarization side at the time of maintenance on the transmitting side.

In contrast to this, in the reception local oscillator synchronization scheme, there is no need to synchronize the local oscillator on the transmitting side, and hence the circuit arrangement on the transmitting side can be simplified. However, in order to demodulate a signal, a demodulator for estimating cross-polarization interference is required in a self polarized wave demodulation device in addition to a demodulator on the different polarization side, resulting in an increase in circuit size on the receiving side. Note that when a digital coherent detection scheme is used for carrier recovery in a demodulator, the reception local oscillator synchronization scheme suitable in terms of hardware arrangement is often used.

This reception local oscillator coherent detection scheme includes two schemes, i.e., a common local oscillator scheme in which a self polarized wave receiver and different polarized wave receiver share one local oscillator and a common reference scheme in which a self polarized wave receiver and different polarized wave receiver independently have local oscillators and share a reference signal for the local oscillators.

According to the common local oscillator scheme, although a simple circuit arrangement can be used, two polarized wave signals may simultaneously fail when mechanical failure occurs in the local oscillator. In contrast, according to the common reference scheme, although a complicated circuit arrangement is required, the influence of mechanical failure in the local oscillator can be limited to only one polarized wave. For this reason, when a strict requirement is imposed on radio wave utilization efficiency and only one spare line at a radio frequency can be provided for two polarized waves, i.e., a V polarized wave and H polarized wave, a highly redundant arrangement is often employed by using the common reference scheme.

According to the reception local oscillator synchronization scheme, since the local oscillator on the transmitting side is asynchronous, an interference component in a space also offset from a self polarized wave signal by a transmission local oscillator frequency difference. If the local oscillator of a receiver is based on the common local oscillator scheme for both RF (Radio Frequency) and IF (Immediate Frequency), the frequency difference between a self polarized wave BB (Base Band) signal and a different polarized wave BB signal is equal to the transmission local oscillator frequency difference. In addition, the phase relationship between the self polarized wave BB signal and the different polarized wave BB signal coincides with the phase relationship in a space. Therefore, an interference component between different polarized waves can be obtained from these two BB signals. That is, in the common local oscillator scheme in which V polarized wave and H polarized wave local oscillator signals on the receiving side are completely phase-locked, interference between different polarized waves can be canceled as described above. In the common reference scheme with high redundancy, i.e., a case wherein different local oscillators are used, although the oscillation frequencies of the two oscillators can be made constant by using a common reference signal, phase noise components produced by the respective local oscillators are independent of each other, and a temporal variation term remains in the phase difference component between the V polarized wave and the H polarized wave.

Although the XPIC for removing interference components can generate a replica signal with respect to a phase difference with no temporal variation, it cannot generate a satisfactory replica signal with respect to a phase difference which quickly varies over time. This is because th XPIC is formed from a transversal filter, and its tap coefficient is generated by an integration circuit. If the follow-up speed is increased by decreasing the number of integration stages, the phase noise suppression amount can be increased. At the same time, however, an output from the XPIC in a steady state contains a large noise component, resulting in a deterioration in BER characteristics. Therefore, decreasing the number of integration stages for the generation of an XPIC tap coefficient to suppress phase noise contradicts an increase in the number of integration stages in accordance with an increase in modulation multilevel. Consequently, as the local oscillator produces a large phase noise component, the cross-polarization interference compensation ability deteriorates.

In order to solve this problem, a conventional technique uses a local oscillator phase difference detector which detects the phase relationship generated by RF local oscillators for orthogonal polarized waves, and an EPS (End-less Phase Shifter) which compensates for the phase difference detected by the local oscillator phase difference detector. According to this technique, the phase relationship between a self polarized wave transmission signal and a different polarized wave interference signal on the RF stage is made to coincide with the phase relationship between a self polarized wave base band signal and a base band XPIC reference signal on the base band stage for interference canceled by compensating for a phase and phase noise component existing in the XPIC reference signal before inputting it to the XPIC, thereby removing a cross-polarization interference component between the two polarized waves (see, Japanese Patent Laid-Open No. 2002-158630).

In this conventional technique, however, the local oscillator phase difference detector, which detects the phase relationship produced by the RF local oscillators, processes frequencies in the RF band, and hence cannot be easily digitalized. This complicates the circuit arrangement.

In the conventional dual polarization transmission receiving system described above, the local oscillator phase difference detector, which detects the phase relationship produced by the RF local oscillators, processes frequencies in the RF band, and hence cannot be easily digitalized. This complicates the circuit arrangement.

### SUMMARY OF THE INVENTION

The present invention has been made to solve such drawbacks in the prior art, and has as its object to provide a digitalized dual polarization transmission receiving system which can prevent a deterioration in cross-polarization interference compensation ability due to local oscillator phase noise by dividing an APC signal obtained by extracting carrier phase information from a modulated output signal into DC and AC components on each of the V polarization side and H polarization side, and supplying a phase control signal obtained by interchanging each AC component on the other polarization side to a demodulation circuit on the XPIC side.

In order to achieve the above object, according to the present invention, there is provided a dual polarization transmission receiving system for canceling cross-polarization interference, comprising reception means including two RF local oscillators (LOs) which receive signals transmitted by using two orthogonal polarized waves (V and H polarized waves) and convert the respective received signals into IF (Immediate Frequency) signals, and demodulation means for branching each IF signal into two paths, and then demodulating the respective IF signals for each polarized wave by a digital coherent detection scheme, wherein the demodulation means for each polarized wave extracts a phase noise component from a demodulated output signal, divides the component into DC and AC components, and suppresses a phase noise amount received from an RF local oscillator for an orthogonally polarized wave (different polarized wave) relative to a polarized wave (self polarized wave) as a compensation target in the demodulateen means for each polariod wave by using a phase control signal obtained by interchanging the DC and AC components between the respective polarized waves.

### BRIEF DESCRIPTION OF THE DRAWINGS

FIG. 1 is a block diagram showing a dual polarization transmission receiving system according to an embodiment of the present invention;

FIG. 2 is a block diagram showing the circuit arrangement of an RF local oscillator in FIG. 1;

FIG. 3 is a block diagram showing the arrangement of a divider in FIG. 1;

FIG. 4 is a graph showing an APC signal when a carrier recovery loop is synchronous; and

FIG. 5 is a block diagram showing a dual polarization transmission receiving system according to another embodiment of the present invention.

### DESCRIPTION OF THE PREFERRED EMBODIMENTS

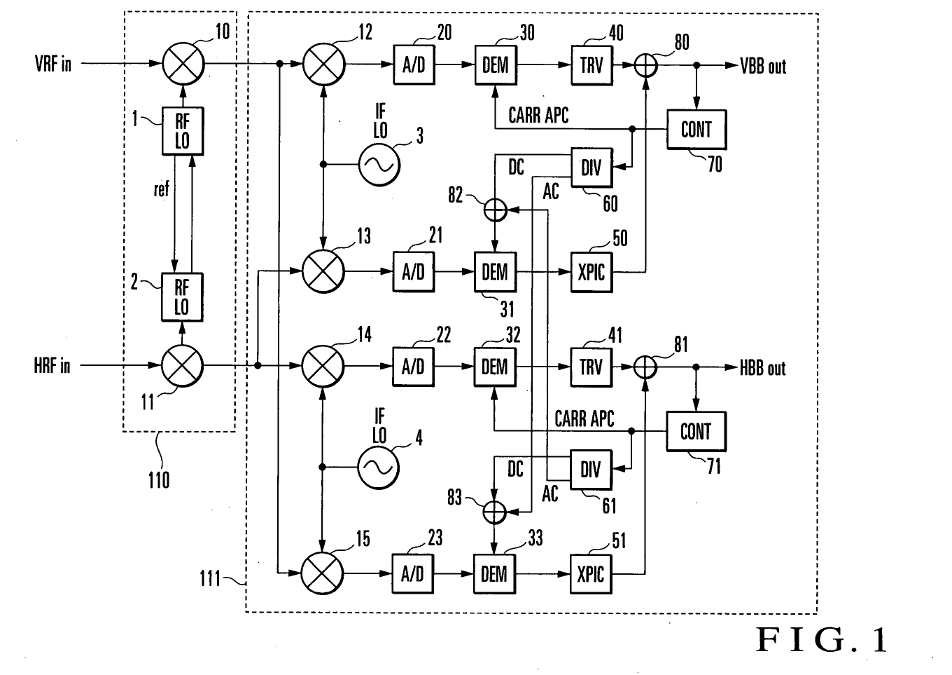

The embodiments of the present invention will be described next with reference to the accompanying drawings. FIG. 1 shows a dual polarization transmission receiving system according to an embodiment of the present invention.

The embodiment shown in FIG. 1 is comprised of RF (Radio Frequency) mixers 10 and 11 which convert signals transmitted by using two orthogonal polarized waves (V polarized wave and H polarized wave) into IF (Immediate frequency) signals, two RF local oscillators (RF LOs) 1 and 2 which are phase-locked by a common reference signal, IF local oscillators (IF LOs) 3 and 4 and IF mixers 12 to 15 which branch each polarized wave IF signal into two paths and perform digital coherent detection of each IF signal, A/D converters 20 to 23 which convert the respective signals having undergone digital coherent detection into digital signals, demodulation circuits 30 to 33 which demodulate the respective converted signals, equalizers 40 and 41 which equalize the waveforms of the demodulated signals of polarized waves (self polarized waves) as compensation targets, XPICs (Cross-Polarization Interference Cancelers) 50 and 51 which generate replica signals of interference components from different polarized waves with respect to the demodulated signals on the different polarization side relative to self polarized waves, adders 80 and 81 which add error signals on the self polarization side, output from the equalizers 40 and 41, to the replica signals output from the XPICs 50 and 51 on the different polarization side, thereby outputting demodulated signals, control circuits 70 and 71 which generate APC (Automatic Phase Control) signals from the added demodulated signals and output them to the demodulation circuits 30 and 32, dividers 60 and 61 which divide the APC signals into DC and AC components, and combiners 82 and 83 which output, to the demodulation circuits 31 and 33, phase control signals obtained by interchanging the DC and AC components output from the dividers 60 and 61.

In this case, a reception means 110 is constituted by the RF local oscillators 1 and 2 and RF mixers 10 and 11. A demodulation means 111 is constituted by the IF local oscillators 3 and 4, IF mixers 12 to 15, A/D converters 20 to 23, demodulation circuits 30 to 33, equalizers 40 and 41, XPICs 50 and 51, dividers 60 and 61, control circuits 70 and 71, and adders 80 and 81.

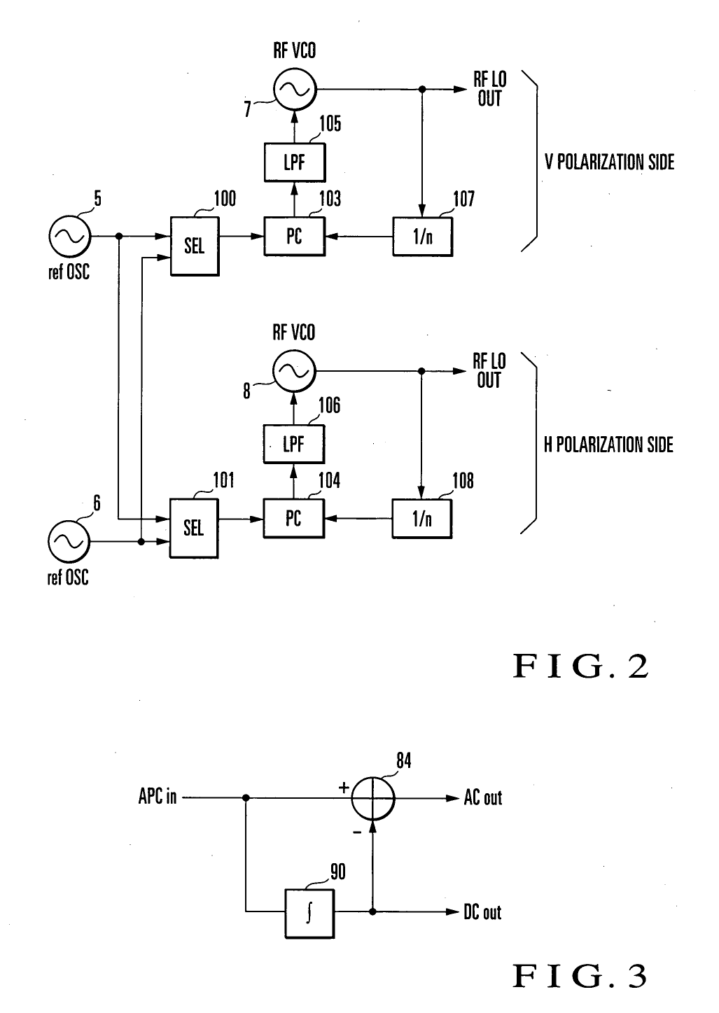

The operation of the dual polarization transmission receiving system according to this embodiment will be described in detail next with reference to FIGS. 1, 2, and 3. FIG. 2 shows the circuit arrangement of an RF local oscillator in FIG. 1. FIG. 3 shows the arrangement of a divider in FIG. 1.

FIG. 1 shows the arrangements on both the V polarization side and the H polarization side. However, in this demodulation device arranged on the output side of the RF mixers 10 and 11, the arrangement and operation on the V polarization side are the same as those on the H polarization side, and hence the operation of the demodulation device will be described only on the V polarization side unless otherwise specified.

In the quadrature modulation scheme, a mixer which converts an IF signal into a BB signal, an A/D converter which converts an analog signal into a digital signal, and the like are provided for each I/Q channel. In this case, however, the arrangements for the two channels are simplified by complex number expression.

Referring to FIG. 1, the RF mixers 10 and 11 respectively receive an RF signal on the V polarization side (VRF) and an RF signal on the H polarization side (HRF) and multiply them by signals from the V polarization side RF local oscillator 1 and H polarization side RF local oscillator 2 to convert the respective RF signals into IF signals.

As shown in FIG. 2, the RF local oscillators 1 and 2 are comprised of reference oscillators 5 and 6 with a redundant arrangement, selectors 100 and 101 which select one of the reference oscillators 5 and 6, RF-band VCOs 7 and 8, frequency dividers 107 and 108 which frequency-divide outputs from the VCOs 7 and 8, phase comparators 103 and 104 which compare the phases of outputs from the frequency dividers 170 and 108 with those of reference signals, and loop filters 105 and 106 which suppress the harmonic components output from the phase comparators 103 and 104 and output control signals for the VCOs 7 and 8. Although the output frequencies of the VCOs 7 and 8 are stable because of establishment of synchronization with the reference signals by PLL operation, phase noise produced by the VCOs 7 and 8 themselves is output without being suppressed as it departs from the loop bands. For this reason, the RF local oscillator signals of the V polarized wave and H polarized wave are equal in frequency owing to phase locking, but the produced phase noise is non-correlated. As a consequence, the respective frequency-converted IF signals contain phase noise.

The IF mixers 12 and 13 on the V polarization side receive outputs from the RF mixers 10 and 11, and multiply them by outputs from the IF local oscillator 3 to convert them into BB signals. With this conversion, a modulated wave having a carrier frequency fc and modulation speed fs is multiplied by an IF local oscillator signal having a frequency fc′ to become a BB signal with a slight frequency difference fc-fc′.

As the IF local oscillator 3, a quartz oscillator is used like the reference oscillators 5 and 6 of the RF local oscillators 1 and 2. An output from the IF local oscillator 3 is branched into two paths. The resultant signals are output for a self polarized wave and different polarized wave, respectively. Therefore, the phase noise of each signal is very small, which is at a negligible level compared with outputs from the RF local oscillators 1 and 2.

The A/D converters 20 and 21 respectively convert th BB signals output from the IF mixers 12 and 13 into digital signals. Assume that the sampling clock for each of the A/D converters 20 and 21 is phase-locked to the clock on the self polarized wave transmitting side. The frequency is 2n (n=1, 2, . . . ) times the modulation speed.

The self polarized wave demodulation circuit (DEM) 30 includes a complex number multiplication circuit and numerical control oscillator (NCO). The demodulation circuit 30 converts a digital APC (Automatic Phase Control) signal corresponding to the shift of the carrier frequency output from the control circuit 70 into a phase amount by integration, and then generates a sine wave (sin, cos) in digital form corresponding to the phase amount. This sine wave has undergone rotational symmetrical conversion in a direction reverse to the phase rotation direction of an input signal to the demodulation circuit 30. Therefore, performing complex number multiplication of the sine wave and the signal output from the A/D converter 20 will remove a residual phase rotation and establish carrier synchronization. The frequency of the sine wave has the slight frequency error fc-fc′ upon establishment of carrier synchronization.

The equalizer (EQL) 40 correlates the error signal output from the control circuit 70 with the signal output from the demodulation circuit 30 to generate a characteristic inverse to intersymbol interference which is a factor that causes a deterioration in the frequency characteristic of a self polarized wave. The equalizer 40 then applies this characteristic to the demodulated signal of the self polarized wave to cancel intersymbol interference from the demodulated signal. As the equalizer 40 for a self polarized wave, a linear equalizer such as a transversal equalizer or a decision feedback equalizer (DFE) is generally used.

The adder 80 adds an output from the equalizer 40 and an output from the XPIC 50 which is a characteristic inverse to an interference component from the different polarization side, and outputs the final modulated signal, on the self polarization side, in which the interference component from the different polarization side, contained therein, is compensated for. If, however, the equalizer 40 is a DFE, a backward equalizer input signal needs to be a signal for making a final decision. For this reason, addition of the signal to an output from the XPIC 50 is performed between the forward equalizer and the backward equalizer.

The control circuit 70 extracts an error signal corresponding to the difference between the position of an ideal signal point and a received signal or the phase information of a carrier, and makes it pass through the loop filter, thereby outputting the obtained APC signal to the demodulation circuit 30 and DIV 60. This APC signal contains a component following self polarized wave phase noise in accordance with the PLL characteristics.

As shown in FIG. 3, the divider 60 is constituted by an adder 84 and integrator 90. The integrator 90 outputs a DC component in accordance with its time constant. Fluctuations in the RF and IF local oscillator frequencies of a transmitter-receiver are fluctuations due to gradual temperature changes. Assuming that the fluctuations are sufficiently slow, DC components corresponding to the frequency functions can be extracted. The adder 84 also outputs an AC component from which a DC component in an output from the integrator 90 is subtracted, i.e., a phase noise component corresponding to a frequency fluctuation.

The combiner 82 receives outputs from the dividers 60 and 61 and outputs a DC component corresponding to a frequency fluctuation as information on the V polarization side, together with an AC component corresponding to phase noise as information on the H polarization side.

The demodulation circuit 31 on the different polarization side has the same function as the demodulation circuit (DEM) 30. However, since the frequency of an Input signal is offset from that on the self polarization side by the V polarized/H polarized wave local oscillator frequency n the transmitting side, the frequency difference of the input signal directly appears in the output for which the same phase rotation as that in the demodulation circuit 30 on the self polarization side is provided. In order to prevent the addition of the influence of the local oscillator phase noise on the V polarization side, in place of a signal from the control circuit 70, the signal obtained by adding the DC component output from the divider 60 on the self polarization side to the AC component output from the divider 61 on the H polarization side is used as a phase control signal to receive phase rotation. This makes it possible to remove a component corresponding to the phase noise from the carrier APC signal on the V polarization side which is the self polarization side.

The XPIC 50 receives an output from the demodulation circuit 31 on the different polarization side, and generates/outputs a characteristic (inverse replica) inverse to an interference component from the different polarization side by using the tap coefficient obtained by calculating the correlation between the received output and the error signal supplied from the self polarization side.

The operation of each component of the demodulation device on the V polarization side has been described above. The same applies to the H polarization side.

Local oscillator phase noise reducing operation will be described next.

First of all, in the self polarized wave demodulation circuit 30, the phase noise output from the RF local oscillator 1 is suppressed by carrier synchronous reproduction, and hence the influence of the phase noise contained in the final modulated signal is removed almost completely. This operation can be mathematically expressed as follows.

Letting Δfv be a transmission/reception local oscillator frequency difference on the V polarization side (the frequency difference between the V polarization side transmission local oscillator and the self polarization side local oscillator), and Pv be local oscillator phase noise, since the phase noise is suppressed by the PLL operation of a carrier recovery circuit (not shown), Δfv is set to “0”, and Pv is made to approach “0”. That is, an output from the demodulation circuit 30 is given by

Δfv+Pv−(Δfv+Pv)=0

Consequently, the influence of the phase noise contained in the final demodulated signal is removed almost completely.

In contrast to this, on the different polarization side, a modulated wave demodulated by the same carrier signal as a self polarized wave demodulation carrier signal has phase noise corresponding to not only the transmission local oscillator frequency difference but also the difference phase noise between the receiving side V polarized wave local oscillator and the H polarized wave local oscillator. Therefore, letting Δfh be a transmission/reception local oscillator frequency difference on the H polarization side, and Ph be phase noise at the H polarization side local oscillator, an output from the demodulation circuit 31 on the different polarization side (XPIC side) has a frequency and phase noise given by

Δfh+Ph−(Δfv+Pv)=(Δfh−Δfv)+(Ph−Pv)

provided that the same phase rotation as that on the self polarization side is given.

In this case, Δfh−Δfv represents a frequency difference in the space where interference has occurred, and hence should be obtained. However, the phase noise Ph−Ph is an unwanted component, which causes a deterioration in interference compensation characteristics unless the local oscillator phase noise is negligibly small.

Obviously, therefore, if Δfv+Ph is added to the demodulation circuit 31 on the XPIC side instead of Δfv+Pv, Δfh−Δfv can be obtained.

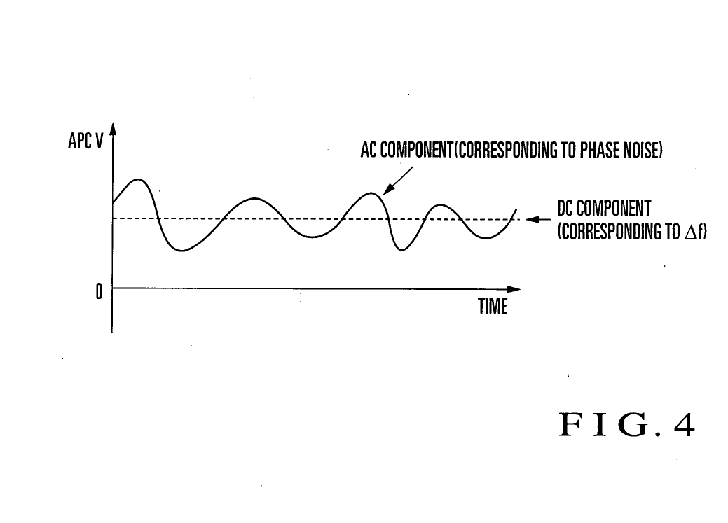

In this case, as shown in FIG. 4, an APC signal with which the carrier recovery loop is synchronous can be regarded as a signal obtained by combining a DC component corresponding to the frequency difference ef the transmitting side local oscillator and an AC component corresponding phase noise which causes an instantaneous phase variation.

The divider 61 receives the carrier APC signal output from the control circuit 70 and divides it into a DC component and AC component.

The combiner 82 adds the DC component output from the divider 60 on the V polarization side to the AC component output from the divider 61 on the H polarization side. That is, the combiner 82 generates a signal (Δfv+Ph) by adding the V polarization side transmission/reception local oscillator frequency difference Δfv to the phase noise Ph of the H polarization side local oscillator. As a consequence, a phase control signal which is not affected by phase noise on the self polarization side and can follow phase noise on the different polarization side and frequency fluctuations on the self polarization side can be used in place of an APC signal.

When the demodulation circuit 31 on the different polarization side performs phase rotation by using this phase control signal, a demodulated signal on the H polarization side can be obtained, from which the influences of both receiving side local oscillator phase noise on the V polarization side and that on the H polarization side are removed. An output from the demodulation circuit 31 therefore contains no phase noise on the V polarization side, and the noise component on the H polarization side is suppressed, thereby maintaining the V polarized wave/H polarized wave frequency relationship in a space.

Note that when the demodulation device on the H polarization side is set in a carrier asynchronous state, no proper information can be obtained from an APC signal on the H polarization side. In this case, the exchange of APC signals between polarized waves is stopped. Although the XPIC characteristics deteriorate because of the lack of the follow-up characteristic of phase noise on the H polarization side, no significant problem arises except when the D/U ratio between polarized waves is extremely low.

Conventionally, in a demodulation device with an XPIC, the XPIC function is reset, i.e., its output is set to “0”, depending on an operation state on the different polarization side. Obviously, the present invention may incorporate such an XPIC reset scheme.

In addition, a clock synchronization circuit may use any scheme as long as phase locking is achieved with respect to a clock on the transmitting side. Since this part has no influence on the operation of the circuit of the present invention, a description thereof will be omitted.

Although not illustrated in the accompanying drawings, no limitation is imposed on the modulation devices corresponding to the demodulation devices in terms of the frequency relationship between th V polarization side local oscillator and the H polarization side local oscillator. That is, it does not matter whether the local oscillators are synchronous or asynchronous. In addition, no limitation is imposed on clocks input to the respective modulation devices in terms of frequency relationship.

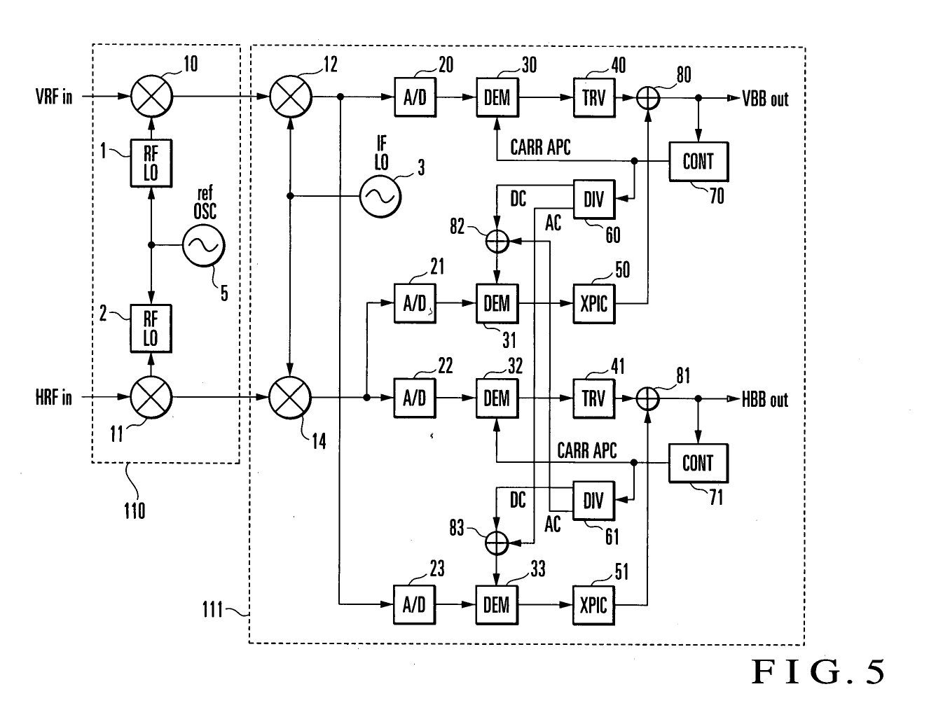

A system having spare lines for both a V polarized wave and an H polarized wave, which is different from the gist of the present invention, i.e., the redundant arrangement for V polarized and H polarized waves, can ensure the reliability of the system even if both a V polarized wave and H polarized wave simultaneously fail. In such a system, circuit sharing can be realized by completely integrating the V polarized wave and H polarized wave demodulation devices. Forming an arrangement like the one shown in FIG. 5 can reduce the cost because there are no circuits with redundant functions. Such integration will facilitate the exchange of APC signals between a V polarized wave and an H polarized wave.

The above description concerns the demodulation device of the BB sampling scheme of A/C-converting a BB signal containing a DC component. However, the present invention can be directly applied to a demodulation device of an IF sampling scheme of temporarily converting an IF signal into a signal in low IF band by using an IF mixer and then A/D-converting the IF signal containing no DC component.

In the arrangement shown in FIG. 1, a bandpass filter or low-pass filter which suppresses unwanted frequency components and extracts only desired frequency components is required for the output of the mixer which is the frequency converter for conversion from an RF signal to an IF signal and from an IF signal to a BB signal. However, since this is a self-evident fact and is not directly associated with the gist of the present invention, a description thereof will be omitted.

As has been described above, according to the dual polarization transmission receiving system and local oscillator phase noise reduction method according to the present invention, phase noise components are extracted from output signals demodulated into a V polarized wave and H polarized wave and divided into DC and AC components, and the resultant signals are fed back to the demodulation circuit on the different polarization side by using the phase control signal obtained by interchanging the AC components between the two polarized waves. This can prevent a deterioration in XPIC characteristics due to independent local oscillator phase noise in the V polarized wave and H polarized wave. Therefore, an XPIC of the reception local oscillator synchronization scheme using a demodulator of the digital coherent detection scheme can be formed.

Consequently, there is no need to use any expensive local oscillator with good phase noise characteristics to implement a redundant arrangement using modulators with XPICs of the reception common reference scheme, leading to an economical advantage.

In addition, a dual polarization transmission redundant arrangement can be implemented in which no instantaneous signal interruption occurs when one polarized wave fails. This makes it possible to improve the reliability of the system.

In order to achieve this effect, only a divider which is constituted by an integrator and adder and designed to divide a carrier APC signal into AC and DC components is required as a circuit to be added to the conventional circuit arrangement. This circuit is very small.

What is claimed is:

1. A dual polarization transmission receiving system for canceling cross-polarization interference, comprising:
reception means including two RF local oscillators which receive signals transmitted by using two orthogonal polarized waves (V and H polarized waves) and convert the respective received signals into IF (Immediate Frequency) signals; and
demodulation means for branching each IF signal into two paths, and then demodulating the respective IF signals for each polarized wave by a digital coherent detection scheme, wherein
said demodulation means for each polarized wave extracts a phase noise component from a demodulated output signal, divides the component into DC and AC components, and suppresses a phase noise amount received from an RF local oscillator for an orthogonally polarized wave (different polarized wave) relative to a polarized wave (self polarized wave) as a compensation target in said demodulation means for each polarized wave by using a phase control signal obtained by interchanging the DC and AC components between the respective polarized waves.

2. A system according to claim 1, wherein said two RF local oscillators are synchronized at the same frequency by a common reference oscillator with a redundant arrangement.

3. A system according to claim 1, wherein said demodulation means extracts a phase noise component from a demodulated output signal, divides the component into DC and AC components, and generates the phase control signal by receiving an AC component from said demodulation means for the other polarized wave (V polarized wave or H polarized wave) and interchanging the AC components.

4. A system according to claim 1, wherein said demodulation means comprises:
a common IF local oscillator which frequency-converts each of the branched IF signals;
two A/D converters which convert the respective frequency-converted signals into digital signals;
two demodulation circuits which demodulate the respective digital signals;
an equalizer which equalizes a waveform of a demodulated signal of a self polarized wave as a compensation target;
an XPIC (Cross-Polarization Interference Canceler) which generates a replica signal of an interference component from a different polarized wave with respect to a demodulated signal on a different polarization side;
an adder which outputs a demodulated signal by adding an error signal output from said equalizer and a replica signal output from said XPIC;
a control circuit which generates an APC (Automatic Phase Control) signal corresponding to a shift of a carrier frequency from the demodulated signal;
a divider which receives the APC signal output from said control circuit and divides the signal into DC and AC components; and
a combiner which outputs the phase control signal obtained by interchanging the DC and AC components between the respective polarized waves.

5. A system according to claim 4, wherein said demodulation means outputs the APC signal, output from said control circuit, to said demodulation circuit which demodulates a self polarized wave digital signal, and also outputs the phase control signal, obtained by combining a DC component output from said divider and an AC component output from said demodulation means for the other polarized wave (V polarized wave or H polarized wave), to said demodulation circuit which demodulates a different polarized wave digital signal.

6. A dual polarization transmission receiving system comprising:
first and second RF (Radio Frequency) mixers which convert signals transmitted by using two orthogonal polarized waves (V polarized wave and H polarized wave) into IF (Immediate Frequency) signals;
first and second RF local oscillators which are phase-controlled by a common reference signal;
a common IF local oscillator and first and second IF mixers which branch each IF signal into two paths and perform digital coherent detection for each of the IF signals for each polarized wave;
first and second A/D converters which convert the respective signals having undergone digital coherent detection into digital signals;
first and second demodulation circuits which demodulate the respective converted signals;
an equalizer which equalizes a waveform of a demodulated signal of a polarized wave (self polarized wave) as a compensation target;
an XPIC (Cross-Polarization Interference Canceler) which generates a replica signal of an interference component from a different polarized wave with respect to a demodulated signal on a different polarization side relative to the self polarized wave;
an adder which outputs a demodulated signal by adding an error signal output from said equalizer to a replica signal output from said XPIC;
a control circuit which generates an APC (Automatic Phase Control) signal corresponding to a shift of a carrier frequency from the demodulated signal and outputs the signal to said first demodulation circuit on the self polarization side;
a divider which divides the APC signal into DC and AC components; and
a combiner which generates a phase control signal by interchanging an AC component output from a divider for the other polarized wave between the two polarized waves, and outputs the signal to said second demodulation circuit on the different polarization side.

7. A local oscillator phase noise reduction method for a dual polarization transmission receiving system, comprising:
the first step of converting signals transmitted by using two orthogonal polarized waves (V polarized wave and H polarized wave) into IF (Immediate Frequency) signals;
the second step of branching each IF signal into two paths and then demodulating each of the IF signals for each polarized wave by a digital coherent detection scheme;
the third step of extracting a phase noise component from the demodulated output signal and dividing the component into DC and AC components;
the fourth step of generating a phase control signal by receiving an AC component of the other polarized wave and interchanging the AC components between the two polarized waves; and
the fifth step of generating a replica signal of an interference component from a different polarized wave for a demodulated signal on a different polarization side relative to a self polarized wave on the basis of the phase control signal in order to suppress a phase noise amount received from an orthogonally polarized wave (different polarized wave) relative to a polarized wave (self polarized wave) as a compensation target.

8. A method according to claim 7, wherein
the second step includes:
the step of frequency-converting each of the branched IF signals;
the step of converting the respective frequency-converted signals into digital signals;
the step of demodulating the respective digital signals;
the step of performing waveform equalization of a demodulated signal of a self polarized wave as a compensation target;
the step of generating a replica signal of an interference component from a different polarized wave with respect to a demodulated signal on a different polarization side; and
the step of outputting a demodulated signal by adding an error signal based on the waveform equalization and the replica signal, and
the third step includes:
the step of generating an APC (Automatic Phase Control) signal corresponding to a shift of a carrier frequency from the demodulated signal; and
the step of dividing the APC signal into DC and AC components.
